(19) United States
(12) Patent Application Publication
(10) Pub. No.: US 2025/0224222 A1
(43) Pub. Date: Jul. 10, 2025

(54) CALIPER MEASURING DEVICE AND MEASURING METHOD USING THE SAME

(71) Applicant: Guilin Gemred Sensor Technology Co., Ltd., Guilin (CN)

(72) Inventors: Bingheng LI, Guilin (CN); Guanglu YANG, Guilin (CN); Xiamei WEN, Guilin (CN); Mengying SHI, Guilin (CN)

(21) Appl. No.: 19/008,689

(22) Filed: Jan. 3, 2025

(30) Foreign Application Priority Data
Jan. 5, 2024 (CN) 202410018381.X

(51) Int. Cl. G01B 3/20

(52) U.S. Cl. CPC G01B 3/205

(57) ABSTRACT

A caliper measuring device, including: a measuring mechanism; a function display mechanism; and a measuring trigger mechanism. The function display mechanism includes an electronic control unit; the measuring trigger mechanism includes a trigger button body and a trigger switch; the function display mechanism is disposed on the measuring mechanism; the trigger switch is connected to the electronic control unit to form a current circuit when the trigger button body is pressed.

### CROSS-REFERENCE TO RELATED APPLICATIONS

Pursuant to 35 U.S.C. § 119 and the Paris Convention Treaty, this application claims foreign priority to Chinese Patent Application No. 202410018381.X filed Jan. 5, 2024, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of measuring tools, and more particularly, to a caliper measuring device and a measuring method using the same.

Typically, caliper measuring includes manually pushing a caliper to enable the caliper measuring surface to contact an object to be measured, and different contact strengths therebetween can result in different measurement results.

As a comparative measurement method, it is necessary to standardize the measurement value of the standard block of the caliper, and then measure the dimensional deviation of the object to be measured relative to the standard block. To minimize the measurement error, it is required that, as far as possible, the measurement strengths for the standard block of the caliper and the object to be measured are basically the same. Force sensing devices can sense a measurement force, and the resulting force measurement can be presented to a user in a variety of forms, e.g., as a force reading on a display, or as an indicator blinking when a force limit value is reached, and the like. The user can control the measurement force according to various indications of the force. However, usually the user does not know what measurement force is appropriate, and even if the user knows the required force, it is not easy to require the user to control the measurement force to a fixed level each time the measurement is taken, thus increasing the difficulty of the user in making accurate measurements.

### SUMMARY

To solve the aforesaid problems, one objective of the disclosure is to provide a caliper measuring device, comprising: a measuring mechanism; a function display mechanism; and a measuring trigger mechanism. The function display mechanism comprises an electronic control unit; the measuring trigger mechanism comprises a trigger button body and a trigger switch; the function display mechanism is disposed on the measuring mechanism; the trigger switch is connected to the electronic control unit to form a current circuit when the trigger button body is pressed.

By setting up the measuring trigger mechanism and connecting the trigger switch of the measuring trigger mechanism with the electronic control unit in the function display mechanism to form a current circuit, it is favorable to connect or disconnect the current circuit by pressing the trigger button body to trigger the trigger switch during the measurement process. When the electronic control unit detects the current circuit is disconnected, the measured value collected by the measuring mechanism is transmitted to the function display mechanism through calculation, and the user only needs to confirm that there is contact between the measuring mechanism and the object to be measured in actual use, which avoids the user from repeatedly adjusting the measuring strength and improves the convenience for measuring.

In a class of this embodiment, the function display mechanism further comprises a housing configured to restrict the trigger button body from moving out, and the measuring trigger mechanism is disposed in a cavity of the housing.

In this way, the trigger button body is located in the cavity of the function display mechanism, and the trigger button body is limited in the cavity and cannot move out; and pressing the trigger button body inward from different directions can trigger the trigger switch and connect the current circuit.

In a class of this embodiment, the trigger button body comprises a first trigger button and a second trigger button which is opposite to the first trigger button; the trigger switch is disposed between the first trigger button and the second trigger button, and is fixedly connected to the first trigger button or the second trigger button.

The first trigger button and second trigger button can adapt to different measurement scenarios. When measuring the outer diameter of the object to be measured, push the second trigger button to the left, so that the second trigger button compresses to the left to contact the trigger switch; when measuring the inner diameter of the object to be measured, push the first trigger button to the right, so that the first trigger button compresses to the right to contact the trigger switch, so as to realize the connection and disconnection of the current circuit, thus improving the convenience for operation.

In a class of this embodiment, the measuring mechanism comprises a finger wheel, a sliding ruler frame, a master ruler, and a push-pull rod; the push-pull rod comprises a first end provided with a first baffle and a second baffle, and a second end provided with a hook; the sliding ruler frame is slidably connected to the master ruler; the finger wheel is disposed on the hook of the push-pull rod; the first baffle and the second baffle are respectively clamped on two side walls of the trigger button body; the function display mechanism is disposed on the sliding ruler frame; a sensor is connected to the electronic control unit for measuring a displacement of the sliding ruler frame with respect to the master ruler.

In this way, the arrangement of the first and second baffles disposed on the push-pull rod is helpful to push the trigger button body by the push-pull rod during measurement, and then drive the trigger button body to press the trigger switch, thus achieving the connection and disconnection of the current circuit.

The disclosure further provides a method for measuring using the above-mentioned caliper measuring device, the method comprising:
1) pushing the measuring mechanism to compress the trigger button body to touch the trigger switch, thereby energizing the current circuit;
2) pushing the measuring mechanism until a measuring jaw of the caliper measuring device comes into contact with a measuring surface of the object to be measured;
3) releasing the measuring mechanism so that the trigger switch restores and the current circuit is disconnected;
4) continuously collecting, by the electronic control unit, sensor values and comparing collected data until a difference between one collected data and a previous one is less than a set value;
5) transmitting, by the electronic control unit, collected data in a last time in 4) to the function display mechanism and displaying the collected data to a user; and
6) performing standard value calibration, and eliminating Abbe errors due to the manufacture and installation of the caliper measuring device.

The following advantages are associated with the caliper measuring device of the disclosure. During measurement, the data collection and filtering function is activated by the turning on/off of the trigger switch, and the same operation method is used during calibration, thus achieving the consistency of measurement forces and high repeatability of measurement results, reducing measurement operation errors caused by different measurement forces and improving actual measurement accuracy.

### BRIEF DESCRIPTION OF THE DRAWINGS

FIG. 1 is a schematic diagram of a caliper measuring device in Example 1 of the disclosure;

FIG. 2 is a schematic diagram of a caliper measuring device in Example 1 of the disclosure with a function display mechanism removed;

FIG. 3 is an exploded view of a function display mechanism in Example 1 of the disclosure;

FIG. 4 is another exploded view of a function display mechanism in Example 1 of the disclosure;

FIG. 5 is a schematic diagram of a measuring trigger mechanism in Example 1 of the disclosure;

FIG. 6 is a schematic diagram of a caliper measuring device according to Example 2 of the disclosure;

FIG. 7 is a schematic diagram of a measuring trigger mechanism according to Example 2 of the disclosure;

FIG. 8 is another schematic diagram of a measuring trigger mechanism according to Example 2 of the disclosure;

FIG. 9 is a schematic diagram of a caliper measuring device according to Example 3 of the disclosure; and

FIG. 10 is a flow chart of a measuring method using the caliper measuring device of the disclosure.

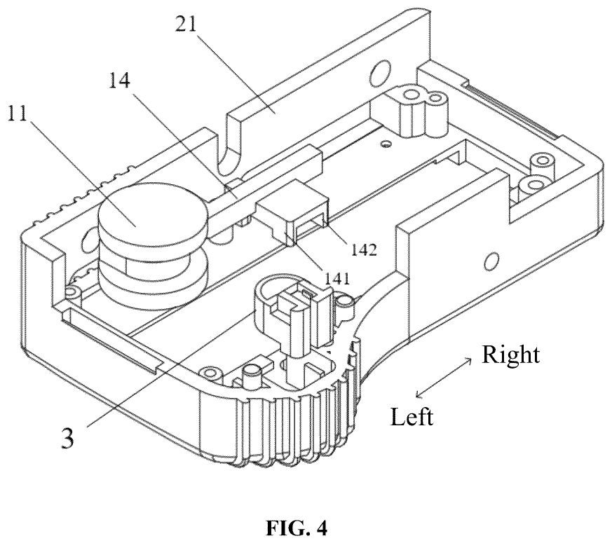

In FIG. 4, bi-directional arrows indicate a mounting orientation of the components of the caliper measuring device.

In the drawings, the following reference numbers are used: 1. Measuring mechanism; 2. Function display mechanism; 3. Measuring trigger mechanism; 11. Finger wheel; 12. Sliding ruler frame; 13. Master ruler; 14. Push-pull rod; 21. Housing; 31. Trigger button body; 32. Trigger switch; 141. First baffle; 142. Second baffle; 311. First trigger button; 312. Second trigger button.

### DETAILED DESCRIPTION

To further illustrate the disclosure, embodiments detailing a caliper measuring device and a measuring method using the same are described below. It should be noted that the following embodiments are intended to describe and not to limit the disclosure.

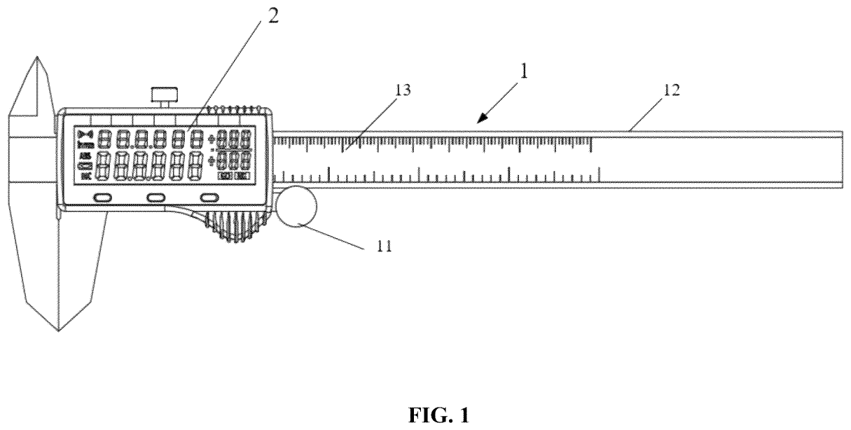

As shown in FIGS. 1-5, the disclosure provides a caliper measuring device, comprising: a measuring mechanism 1; a function display mechanism 2; and a measuring trigger mechanism 3. The function display mechanism comprises an electronic control unit; the measuring trigger mechanism 3 comprises a trigger button body 31 and a trigger switch 32; the function display mechanism 2 is disposed on the measuring mechanism 1; the trigger switch 32 is connected to the electronic control unit to form a current circuit when the trigger button body 31 is pressed.

Understandably, the trigger button body 31 and the trigger switch 32 are combined as a triggering member.

By setting up the measuring trigger mechanism and connecting the trigger switch of the measuring trigger mechanism with the electronic control unit in the function display mechanism to form a current circuit, it is favorable to connect or disconnect the current circuit by pressing the trigger button body to trigger the trigger switch during the measurement process. When the electronic control unit detects the current circuit is disconnected, the measured value collected by the measuring mechanism is transmitted to the function display mechanism through calculation, and the user only needs to confirm that there is contact between the measuring mechanism and the object to be measured in actual use, which avoids the user from repeatedly adjusting the measuring strength and improves the convenience for measuring.

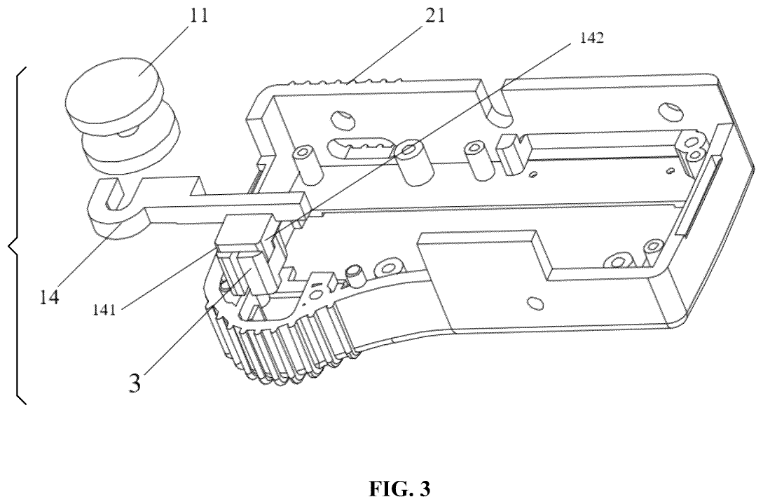

Preferably, as shown in FIGS. 3 and 4, the function display mechanism 2 further comprises a housing 21 configured to restrict the trigger button body 31 from moving out, and the measuring trigger mechanism 3 is disposed in a cavity of the housing 21.

Understandably, moving out means the trigger button body 31 moves out of the housing 21.

In this way, the trigger button body is located in the cavity of the function display mechanism, and the trigger button body is limited in the cavity and cannot move out; and pressing the trigger button body inward from different directions can trigger the trigger switch and connect the current circuit.

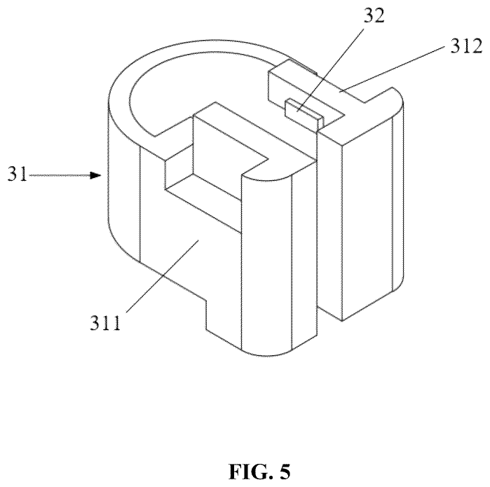

Preferably, as shown in FIG. 5, the trigger button body 31 comprises a first trigger button 311 and a second trigger button 312 which is opposite to the first trigger button; the trigger switch 32 is disposed between the first trigger button 311 and the second trigger button 312, and is fixedly connected to the first trigger button 311 or the second trigger button 312.

The first trigger button and second trigger button can adapt to different measurement scenarios. For example, when measuring the outer diameter of the object to be measured, push the second trigger button to the left, so that the second trigger button compresses to the left to contact the trigger switch; when measuring the inner diameter of the object to be measured, push the first trigger button to the right, so that the first trigger button compresses to the right to contact the trigger switch, so as to realize the connection and disconnection of the current circuit, thus improving the convenience for operation.

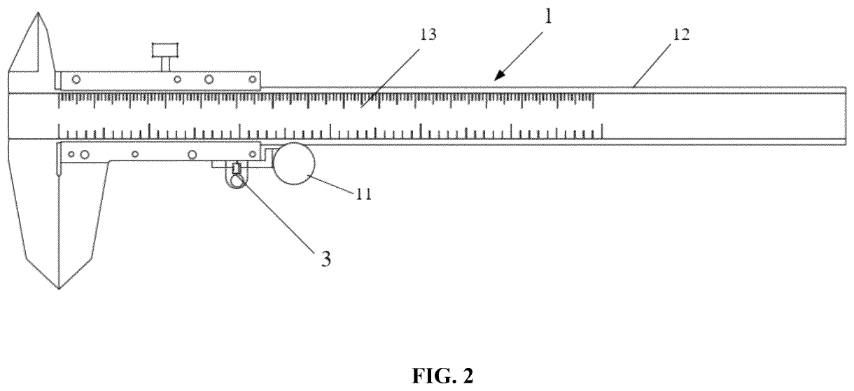

Preferably, as shown in FIGS. 1 and 2, the measuring mechanism 1 comprises a finger wheel 11, a sliding ruler frame 12, a master ruler 13, and a push-pull rod 14; the push-pull rod 14 comprises a first end provided with a first baffle 141 and a second baffle 142, and a second end provided with a hook; the sliding ruler frame 12 is slidably connected to the master ruler 13; the finger wheel 11 is disposed on the hook of the push-pull rod 14; the first baffle 141 and the second baffle 142 are respectively clamped on two side walls of the trigger button body 31; the function display mechanism 2 is disposed on the sliding ruler frame 12; a sensor is connected to the electronic control unit for measuring a displacement of the sliding ruler frame 12 with respect to the master ruler 13.

In this way, the arrangement of the first and second baffles disposed on the push-pull rod is helpful to push the trigger button body by the push-pull rod during measurement, and then drive the trigger button body to press the trigger switch, thus achieving the connection and disconnection of the current circuit.

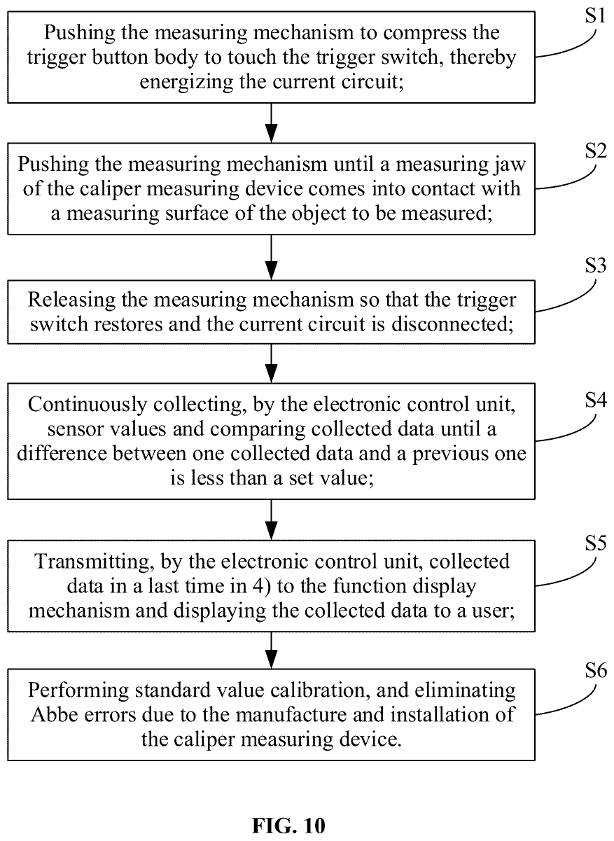

As shown in FIG. 10, the disclosure also provides a method for measuring using the caliper measuring device, the method comprising:
1) pushing the measuring mechanism 1 to compress the trigger button body (31) to touch the trigger switch 32, thereby energizing the current circuit;
2) pushing the measuring mechanism 1 until a measuring jaw of the caliper measuring device comes into contact with a measuring surface of the object to be measured;
3) releasing the measuring mechanism 1 so that the trigger switch 32 restores and the current circuit is disconnected;
4) continuously collecting, by the electronic control unit, sensor values and comparing collected data until a difference between one collected data and a previous one is less than a set value;
5) transmitting, by the electronic control unit, collected data in a last time in 4) to the function display mechanism 2 and displaying the collected data to a user; and
6) performing standard value calibration, and eliminating Abbe errors due to the manufacture and installation of the caliper measuring device.

In 1), there are different methods for energizing current circuits in different examples: in Example 2, the finger wheel 11 is pushed to the left or right, and the finger wheel 11 drives the sliding ruler frame 12 and the trigger button body 31 installed on the sliding ruler frame 12 to move left or right to touch the trigger switch 32, thereby energizing the current circuit; in Example 3, the trigger button body 31 is directly pressed down to energize the current circuit of the trigger switch 32; in Example 1, by pushing the finger wheel 11 to the left or right, the finger wheel 11 drives the push-pull rod 14, the first baffle 141, and the second baffle 142 to move left and right, thereby causing the trigger button body 31 to move left or right to touch the trigger switch 32, thereby energizing the current circuit.

In 2), after the trigger switch 32 disconnects the current circuit, due to the absence of external force, the force between the measuring claw of the caliper measuring device and the measuring surface of the object to be measured will gradually be released.

In 4), the sensor is used to measure the displacement of the sliding ruler frame 12 relative to the master ruler 13, that is, the distance between the two measuring claws of the caliper measuring device. The comparison calculation of the input signals performed by the electronic control unit is as follows: when Aₙ (nth sampling data)−A₍ₙ₋₁₎ ((n-1)th sampling data)≤N (preferably, N is 0.001 mm), it is considered that the output value is stable and reliable. The electronic control unit will output the nth sampling data as the measurement value, which is the size of the object to be measured.

In 6), due to the manufacturing and installation errors of the caliper measuring device, it is impossible to completely avoid angular motion, and thus Abbe errors occur. The method of standard value calibration is to first measure the size of any standard measuring block (such as a standard measuring block with a size of 50 mm) with a caliper, and then set the measurement point of the standard measuring block to 50 mm. When measuring again, the 50 mm point is used as the standard measurement point for proportional correction measurement. The Abbe errors of all subsequent measurement values are compensated, thereby improving measurement accuracy. For example, multi-point calibration is used for proportional corrections for each calibration point to improve the measurement accuracy of the entire measurement range.

The following advantages are associated with the caliper measuring device of the disclosure. During measurement, the data collection and filtering function is activated by the turning on/off of the trigger switch, and the same operation method is used during calibration, thus achieving the consistency of measurement forces and high repeatability of measurement results, reducing measurement operation errors caused by different measurement forces and improving actual measurement accuracy.

### Example 1

As shown in FIGS. 1-5, the trigger button body 31 and the trigger switch 32 are disposed inside the cavity of the housing 21, and the finger wheel 11 is disposed on the hook of the push-pull rod 22 and outside the cavity. When measuring the outer diameter, push the finger wheel 11 to the left. The finger wheel 11 drives the sliding ruler frame 12 to slide to the left. The finger wheel 11 drives the push-pull rod 14 to continue to move to the left. The second baffle 142 on the push-pull rod 14 drives the second trigger button 312 to press the trigger switch 32. The trigger switch 32 is closed to energize the current circuit. After the user confirms that the measuring claw of the caliper is in contact with the measuring surface of the object to be measured, the finger wheel 11 is released, and the trigger switch 32 is disconnected at the same time. After the electronic control unit receives the disconnection signal of the trigger switch 32, the force of the measuring claw of the caliper on the surface of the object to be measured is gradually released due to the absence of external force after releasing the trigger button body 31. During the gradual release process, the output value of the sensor for measuring the displacement of the sliding ruler frame 12 relative to the master ruler 13 tends to stabilize with a small fluctuation. The sensor values are continuously collected and the collected data are compared, when Aₙ (nth sampling data)−A₍ₙ₋₁₎≤N (as an example, N is taken 0.001 mm), it is considered that the output value has become reliable. The electronic control unit will output the value as the measurement value and display it on the monitor.

When measuring the inner diameter, push the finger wheel 11 to the right, and the finger wheel 11 drives the sliding ruler frame 12 to slide to the right. The finger wheel 11 drives the push-pull rod 14 to continue to move to the right. The first baffle 141 on the push-pull rod 14 drives the first trigger button 311 to press the trigger switch 32, and the trigger switch 32 is closed to energize the current circuit; when the user confirms that the measuring claw of the caliper is in contact with the measuring surface of the object to be measured, the finger wheel 11 is released, and the trigger switch 32 is disconnected at the same time. After receiving the disconnection signal from the trigger switch 32, the electronic control unit will automatically collect and display data. The data collection and calculation process is the same as the operation when measuring the outer diameter, and will not be repeated here.

On the basis of the embodiment, a button cap is disposed on the side wall of the first trigger button 311 away from the trigger switch 32 and the side wall of the second trigger button 312 away from the trigger switch 32. Users can directly press the button cap to drive the trigger button body 31 to move left and right to achieve the measurement of inner and outer diameters. The benefit of the design is that the inner and outer dimensions can be optionally measured through one trigger switch 32, simplifying the measurement and judgment control method, and the optimal driving operation position can be conveniently arranged.

### Example 2

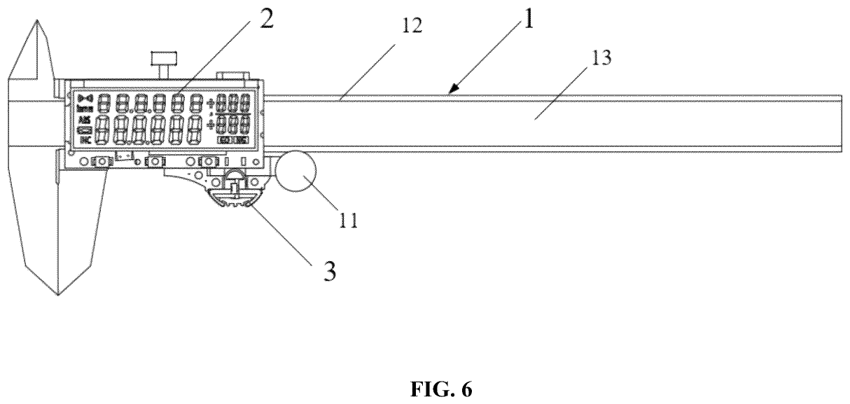

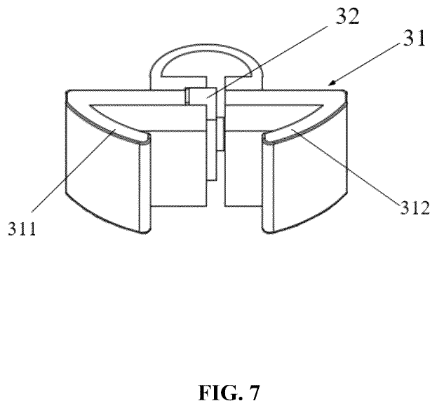

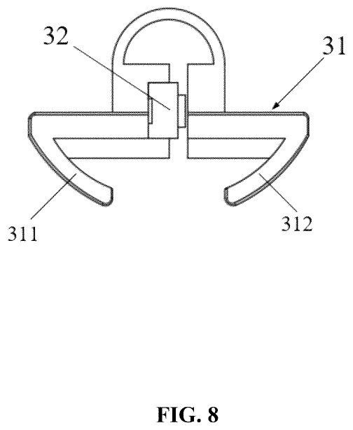

As shown in FIGS. 6-8, the trigger button body 31 and the trigger switch 32 are disposed on the bottom of the sliding ruler frame 12, and the finger wheel 11 is disposed on the sliding ruler frame 12.

To measure the outer diameter of the object to be measured, press the second trigger button 312 and push the sliding ruler frame 12 to the left. During this process, pressing the second trigger button 312 will compress and close the trigger switch 32, causing the current circuit to be conductive until the user observes that the measuring claw of the caliper is in contact with the measuring surface of the object to be measured. Then, release the second trigger button 312, and the trigger switch 32 will be disconnected at the same time. After receiving the disconnection signal from the trigger switch 32, the electronic control unit will automatically collect and display data. The data collection and calculation process is the same as in Example 1, and will not be repeated here.

To measure the inner diameter, press the first trigger button 311 and push the sliding ruler frame 12 to the right. Pressing the first trigger button 311 will drive the trigger switch 32 to move to the right. After the trigger switch 32 moves to the right, it will press against the second trigger button 312. The second trigger button 312 presses against the trigger switch 32, causing the trigger switch 32 to close and the current circuit to be conductive until the user observes that the measuring claw of the caliper is in contact with the measuring surface of the object to be measured. Then, release the second trigger button 312, and the trigger switch 32 will be disconnected. After receiving the disconnection signal from the trigger switch 32, the electronic control unit will automatically collect and display data. The data collection and calculation process is the same as in Example 1, and will not be repeated here.

### Example 3

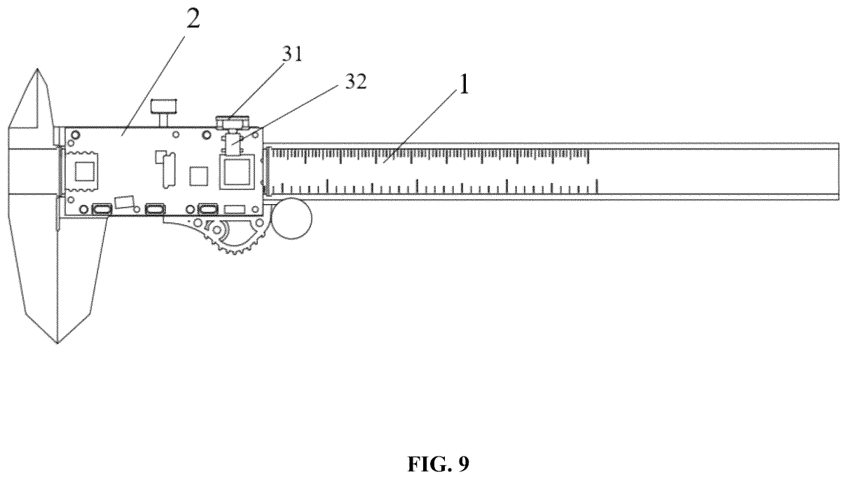

As shown in FIG. 9, the trigger button body 31 and the trigger switch 32 are disposed on the top of the sliding ruler frame 12, and the finger wheel 11 is disposed on the sliding ruler frame 12.

When measuring, the user presses down on the trigger button body 31 with one finger and simultaneously pushes the sliding ruler frame 12 to the left or right for measurement. The trigger button body 31 drives the trigger switch 32 to be in a closed state. When the user confirms that the measuring claw of the caliper is in contact with the measuring surface of the object to be measured, then releases the trigger button body 31, and the trigger switch 32 is disconnected. After receiving the disconnection signal of the trigger switch 32, the electronic control unit will automatically collect and display data. The calculation process is the same as that in Example 1 and will not be repeated here.

The second and third examples are variations of the disclosure, with the same working principle as that in Example 1, but simplified and modified structures, and should also fall within the scope of protection of the disclosure.

The terms “first” and “second” are only used for descriptive purposes and cannot be understood as indicating or implying relative importance or implying the number of technical features indicated. Therefore, the features that are limited to “first” and “second” can explicitly or implicitly include at least one of these features. In the description of the disclosure, “multiple” means at least two, such as two, three, etc., unless otherwise stated.

In the disclosure, unless otherwise specified and limited, the terms “installation”, “connection”, “fixation”, etc. should be broadly understood, for example, they can be fixed connections, detachable connections, or integrated. It can be a mechanical connection or an electrical connection. It can be directly connected or indirectly connected through an intermediate medium, and can be a connection within two components or an interaction relationship between two components, unless otherwise specified. For ordinary technical personnel in this field, the specific meanings of the above terms in the disclosure can be understood according to the specific situation.

In the disclosure, unless otherwise specified and limited, the first element may be in direct contact with the second element “above” or “below” the first element, or the first and second elements may be in indirect contact through an intermediate medium. Moreover, the first element being “above” the second element may indicate that the first element is directly above or diagonally above the second element, or simply that the first element is horizontally higher than the second element. The first element can be located directly or diagonally below the second element, or simply indicate that the first element has a lower horizontal height than the second element.

It will be obvious to those skilled in the art that changes and modifications may be made, and therefore, the aim in the appended claims is to cover all such changes and modifications.

What is claimed is:

1. A caliper measuring device, comprising:
a measuring mechanism;
a function display mechanism; and
a measuring trigger mechanism;
wherein,
the function display mechanism comprises an electronic control unit;
the measuring trigger mechanism comprises a trigger button body and a trigger switch;
the function display mechanism is disposed on the measuring mechanism; and
the trigger switch is connected to the electronic control unit to form a current circuit when the trigger button body is pressed.

2. The caliper measuring device of claim 1, wherein the function display mechanism further comprises a housing configured to restrict the trigger button body from moving out, and the measuring trigger mechanism is disposed in a cavity of the housing.

3. The caliper measuring device of claim 1, wherein the trigger button body comprises a first trigger button and a second trigger button which is opposite to the first trigger button; the trigger switch is disposed between the first trigger button and the second trigger button, and is fixedly connected to the first trigger button or the second trigger button.

4. The caliper measuring device of claim 1, wherein the measuring mechanism comprises a finger wheel, a sliding ruler frame, a master ruler, and a push-pull rod; the push-pull rod comprises a first end provided with a first baffle and a second baffle, and a second end provided with a hook; the sliding ruler frame is slidably connected to the master ruler; the finger wheel is disposed on the hook of the push-pull rod; the first baffle and the second baffle are respectively clamped on two side walls of the trigger button body; the function display mechanism is disposed on the sliding ruler frame; a sensor is connected to the electronic control unit for measuring a displacement of the sliding ruler frame with respect to the master ruler.

5. A method for measuring using the caliper measuring device of claim 1, the method comprising:
1) pushing the measuring mechanism to compress the trigger button body to touch the trigger switch, thereby energizing the current circuit;
2) pushing the measuring mechanism until a measuring jaw of the caliper measuring device comes into contact with a measuring surface of the object to be measured;
3) releasing the measuring mechanism so that the trigger switch restores and the current circuit is disconnected;
4) continuously collecting, by the electronic control unit, sensor values and comparing collected data until a difference between one collected data and a previous one is less than a set value;
5) transmitting, by the electronic control unit, collected data in a last time in 4) to the function display mechanism and displaying the collected data to a user; and
6) performing standard value calibration, and eliminating Abbe errors due to the manufacture and installation of the caliper measuring device.
